(19) United States
(12) Patent Application Publication
(10) Pub. No.: US 2009/0257014 A1
(43) Pub. Date: Oct. 15, 2009

(54) LIQUID CRYSTAL DEVICE AND ELECTRONIC APPARATUS

(75) Inventor: Akihide Haruyama, Suwa-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/415,245

(22) Filed: Mar. 31, 2009

(30) Foreign Application Priority Data
Apr. 10, 2008 (JP) 2008-102191

(51) Int. Cl. G02F 1/1343

(52) U.S. Cl. 349/139

(57) ABSTRACT

A liquid crystal device includes: a first substrate; a second substrate disposed to face the first substrate; a liquid crystal layer being disposed between the first substrate and the second substrate and having both of a splay alignment state and a bend alignment state; a plurality of gate lines formed on a surface of the first substrate facing the liquid crystal layer; a plurality of source lines formed on the surface of the first substrate facing the liquid crystal layer to intersect the gate lines in a plan view; switching elements formed on the surface of the first substrate facing the liquid crystal layer to correspond to the intersections of the gate lines and the source lines; and pixel electrodes formed on the surface of the first substrate facing the liquid crystal layer and electrically connected to the switching elements. Here, each pixel electrode has an overlap area overlapping with a part of the gate lines or the source lines in a plan view and has a stepped portion between the overlap area and an area other than the overlap area.

### BACKGROUND

1. Technical Field

The present invention relates to a liquid crystal device and an electronic apparatus, and more particularly, to a liquid crystal device employing an optically compensated birefringence (OCB) mode.

2. Related Art

In OCB-mode liquid crystal devices, a liquid crystal layer enclosed between a pair of substrates is configured to have both of a splay alignment state and a bend alignment state. The liquid crystal layer is aligned in the splay alignment state in the initial state and is transferred to the bend alignment state with an application of a transfer voltage at the time of displaying an image. In the OCB-mode liquid crystal devices, since a displaying operation is performed by modulating transmittance on the basis of a degree of bending of the bend alignment at the time of displaying an image, there is an advantage that it has a rapid response.

FIGS. 15A and 15B show an example of a pixel structure of an OCB-mode liquid crystal device, where FIG. 15A is a plan view and FIG. 15B is a sectional view taken along line XVB-XVB′ of FIG. 15A. The liquid crystal device includes an element substrate 10, a counter substrate 30, and a liquid crystal layer 40 disposed between the element substrate 10 and the counter substrate 30. Plural gate lines 12 arranged in parallel to each other and plural source lines 14 parallel to each other are formed on the element substrate 10 and thin film transistor (TFT) elements 20 are formed to correspond to intersections of the gate lines 12 and the source lines 14. A pixel electrode 16 is electrically connected to each TFT element 20. The pixel electrode 16 is formed in an area surrounded with two gate lines 12 and two source lines 14. Gaps are formed between the pixel electrodes 16 and the gate lines 12 and the source lines 14 in a plan view.

When the liquid crystal layer 40 is transferred from a splay alignment state to a bend alignment state, a transfer voltage is applied across the gate line 12 and the pixel electrode 16. At this time, an electric field F having electric force lines connecting the gate line 12 and the pixel electrode 16 is generated in the liquid crystal layer 40 as shown in FIG. 15B. Liquid crystal molecules 40a included in the liquid crystal layer 40 tend to change their alignment directions depending on the electric field F and to be transferred to the bend alignment. Transfer nucleuses for the bend alignment are generated in a concave portion 60 between the gate line 12 and the pixel electrode 16 or in the vicinity thereof at the initial time. Thereafter, by applying the transfer voltage across the pixel electrode 16 and a common electrode 36 of the counter substrate 30, a bend alignment area can be expanded from the transfer nucleuses onto the pixel electrode 16. In this way, the splay alignment is transferred to the bend alignment. This transfer method is disclosed in JP-A-2001-296519.

However, in the above-mentioned liquid crystal device, since the gate line 12 and the pixel electrode 16 are apart from each other in a plan view, it is difficult to obtain satisfactory intensity of the electric field F generated with the application of the transfer voltage and to generate the transfer nucleus. Since a distance exists between the gate line 12 and the pixel electrode 16, it is difficult to cause the bend alignment area to be expanded onto the pixel electrode 16 from the transfer nucleuses generated in the concave portion 60 outside the pixel electrode 16. As a result, a high transfer voltage is required for expanding the bend alignment area onto the pixel electrode 16, thereby causing a problem that the power consumption of the transfer operation to the bend alignment increases or a problem that much time is taken for the transfer operation.

### SUMMARY

An advantage of some aspects of the invention is to solve at least a part of the above-mentioned problems.

According to an aspect of the invention, there is provided a liquid crystal device including: a first substrate; a second substrate disposed to face the first substrate; a liquid crystal layer being disposed between the first substrate and the second substrate and having both of a splay alignment state and a bend alignment state; a plurality of gate lines formed on a surface of the first substrate facing the liquid crystal layer; a plurality of source lines formed on the surface of the first substrate facing the liquid crystal layer to intersect the gate lines in a plan view; switching elements formed on the surface of the first substrate facing the liquid crystal layer to correspond to the intersections of the gate lines and the source lines; and pixel electrodes formed on the surface of the first substrate facing the liquid crystal layer and electrically connected to the switching elements. Here, each pixel electrode has an overlap area overlapping with a part of the gate lines or the source lines in a plan view and has a stepped portion between the overlap area and an area other than the overlap area.

According to this configuration, when a transfer voltage is applied across the gate lines or the source lines and the pixel electrodes, liquid crystal molecules twist and get upright due to a transverse electric field in the overlap area of each pixel electrode overlapping the gate lines or the source lines. On the other hand, in a taper of the stepped portion between the overlap area and the area other than the overlap area, a tilt angle of the liquid crystal molecules about the surface of the first substrate increases. Accordingly, by applying the transfer voltage, it is possible to easily generate the transfer nucleuses of the bend alignment by the synergy effect of the twist in alignment of the liquid crystal molecules in the overlap area and the tilt angle of the liquid crystal molecules in the stepped portion. According to the above-mentioned configuration, since the pixel electrode overlaps with the corresponding gate line or the source line in the overlap area, a two-dimensional gap is not formed between the gate line or the source line and the pixel electrode and thus the concave portion is not formed in the overlap area. Accordingly, it is possible to easily expand the bend alignment area onto the pixel electrode from the transfer nucleuses at the time of applying the transfer voltage. In this specification, the “transfer voltage” means a voltage for transferring the liquid crystal layer from the splay alignment to the bend alignment. The “plan view” means a view in the normal line direction of the first substrate.

In the liquid crystal device, the height of the stepped portion may be in the range of 0.1 μm to 2.0 μm.

By setting the height of the stepped portion to 0.1 μm or more, a satisfactory taper angle can be obtained in the stepped portion and thus the tilt angle of the liquid crystal molecules in the taper of the stepped portion can be set to a magnitude contributing to the generation of the bend nucleus. By setting the height of the stepped portion to 2.0 μm or less, an electric field having a satisfactory magnitude can be generated between the gate line or the source line and the overlap area of the pixel electrode and thus the degree of twist in alignment of the liquid crystal molecules in the overlap area can be set to a magnitude contributing to the generation of the bend nucleus. As a result, by setting the height of the stepped portion to the range of 0.1 μm to 2.0 μm, it is possible to obtain the synergy effect of the twist in alignment of the liquid crystal molecules in the overlap area and the tilt angle of the liquid crystal molecules in the stepped portion for the generation of the transfer nucleus.

In the liquid crystal device, the overlap area may overlap with a part of the corresponding gate line in a plan view and an auxiliary electrode formed in the same layer as the source lines may be provided in an area overlapping with at least a part of the overlap area in a plan view.

According to this configuration, the height of the stepped portion can be made to be greater by the thickness of the auxiliary electrode than that of the configuration not having the auxiliary electrode. By adjusting the thickness of the auxiliary electrode, the height of the stepped portion can be set to a desired value. When the transfer voltage is applied, an electric field having a great strength can be generated between the auxiliary electrode and the pixel electrode, thereby easily generating the transfer nucleus.

In the liquid crystal device, the overlap area may overlap with a part of the corresponding source line, and an auxiliary electrode formed in the same layer as the gate lines may be provided in an area overlapping with at least a part of the overlap area.

According to this configuration, the height of the stepped portion can be made to be greater by the thickness of the auxiliary electrode than that of the configuration not having the auxiliary electrode. By adjusting the thickness of the auxiliary electrode, the height of the stepped portion can be set to a desired value.

In the liquid crystal device, the gate lines or the source lines may have a curved portion, a side of each pixel electrode may be curved along the curved portion, and the overlap area of the pixel electrode may be disposed along the curved side.

According to this configuration, the overlap area of the pixel electrode overlaps with the corresponding gate line or the corresponding source line in the curved portion. Accordingly, when the transfer voltage is applied, transverse electric fields having different directions can be generated in the overlap area. Therefore, it is possible to more easily generate the transfer nucleus.

In the liquid crystal device, each pixel electrode may have two sides extending along two neighboring gate lines and two sides extending along two neighboring source lines and the overlap area of the pixel electrode may overlap with a part of at least one of the gate line and the source line not electrically connected to the pixel electrode through the switching element among the two gate lines and the two source lines in a plan view.

According to this configuration, the overlap area of the pixel electrode partially overlaps with the gate line or the source line not electrically connected to the pixel electrode itself. Accordingly, even when a parasitic capacitor is generated due to the overlapping with the gate line or the source line, it is possible to suppress the parasitic capacitor from having an influence on display. Since the number of gate lines or source lines overlapping the pixel electrode or the overlapping area thereof is defined, it is possible to reduce the parasitic capacitance resulting from the overlap.

The liquid crystal device may further include: a reflecting film formed on an area along the curved portion in a plan view on the surface of the first substrate facing the liquid crystal layer; and a liquid-crystal-layer thickness adjusting layer formed in an area overlapping with the reflecting film in a plan view on a surface of the second substrate facing the liquid crystal layer.

According to this configuration, with the application of the transfer voltage, the transfer nucleuses are generated in the area in which the reflecting film and the liquid-crystal-layer thickness adjusting layer are formed or in the vicinity thereof. Here, the thickness of the liquid crystal layer in the area in which the reflecting film is formed is smaller by the thickness of the liquid-crystal-layer thickness adjusting layer than the thickness of the liquid crystal layer in the area in which the reflecting film is not formed. Accordingly, the strength of the electric field due to the transfer voltage increases in the area in which the reflecting film is formed, thereby expanding the bend alignment area for a short time. Therefore, according to the above-mentioned configuration, it is possible to expand the bend alignment area along the area in which the reflecting film is formed for a short time.

According to another aspect of the invention, there is provided an electronic apparatus including the above-mentioned liquid crystal device.

According to this configuration, it is possible to obtain an electronic apparatus capable of transferring the liquid crystal device to a bend alignment mode with low power consumption for a short time.

### BRIEF DESCRIPTION OF THE DRAWINGS

The invention will be described with reference to the accompanying drawings, wherein like numbers reference like elements.

FIGS. 1A and 1B are diagrams illustrating a configuration of a liquid crystal device, where FIG. 1A is a perspective view and FIG. 1B is a sectional view taken along line IB-IB of FIG. 1A.

FIG. 2 is a diagram schematically illustrating alignment of liquid crystal molecules in a splay alignment state and a bend alignment state.

FIG. 3 is an enlarged plan view of a display area.

FIG. 4 is an equivalent circuit diagram illustrating various elements and lines in the display area of the liquid crystal device.

FIGS. 5A and 5B are diagrams illustrating a configuration of a pixel in a liquid crystal device according to a first embodiment of the invention, where FIG. 5A is a plan view as viewed from a counter substrate side and FIG. 5B is a sectional view taken along line VB-VB of FIG. 5A.

FIG. 6 is a sectional view taken along line VI-VI of FIG. 5A.

FIG. 7 is a graph illustrating a relation between a height of a stepped portion and a transferred nucleus formation time.

FIGS. 8A and 8B are diagrams illustrating a configuration of a pixel in a liquid crystal device according to a second embodiment of the invention, where FIG. 8A is a plan view as viewed from a counter substrate side and FIG. 8B is a sectional view taken along line VIIIB-VIIIB of FIG. 8A.

FIGS. 9A and 9B are diagrams illustrating a configuration of a pixel in a liquid crystal device according to a third embodiment of the invention, where FIG. 9A is a plan view as viewed from a counter substrate side and FIG. 9B is a sectional view taken along line IXB-IXB of FIG. 9A.

FIGS. 10A and 10B are diagrams illustrating a configuration of a pixel in a liquid crystal device according to a fourth embodiment of the invention, where FIG. 10A is a plan view as viewed from a counter substrate side and FIG. 10B is a sectional view taken along line XB-XB of FIG. 10A.

FIGS. 11A and 11B are diagrams illustrating a configuration of a pixel in a liquid crystal device according to a fifth embodiment of the invention, where FIG. 11A is a plan view as viewed from a counter substrate side and FIG. 11B is a sectional view taken along line XIB-XIB of FIG. 11A.

FIGS. 12A and 12B are diagrams illustrating a configuration of a pixel in a liquid crystal device according to a sixth embodiment of the invention, where FIG. 12A is a plan view as viewed from a counter substrate side and FIG. 12B is a sectional view taken along line XIIB-XIIB of FIG. 12A.

FIGS. 13A and 13B are diagrams illustrating an overlap area of a pixel electrode, where FIG. 13A is a plan view and FIG. 13B is a sectional view taken along line XIIIB-XIIIB of FIG. 13A.

FIG. 14 is a perspective view illustrating a mobile phone as an electronic apparatus.

FIGS. 15A and 15B are diagrams illustrating an example of a pixel structure in an OCB-mode liquid crystal device, where FIG. 15A is a plan view and FIG. 15B is a sectional view taken along line XVB-XVB of FIG. 15A.

### DESCRIPTION OF EXEMPLARY EMBODIMENTS

Hereinafter, a liquid crystal device and an electronic device according to embodiments of the invention will be described with reference to the drawings. In the drawings, sizes or scales of elements are shown properly different from actual ones so as to recognize the elements in the drawings.

### First Embodiment

### A. Configuration of Liquid Crystal Device

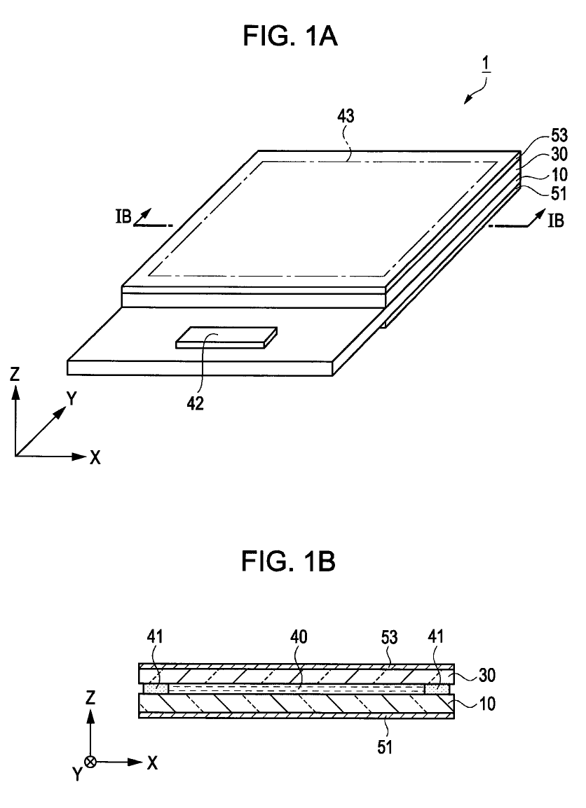

FIGS. 1A and 1B are diagrams illustrating a configuration of a liquid crystal device 1, where FIG. 1A is a perspective view and FIG. 1B is a sectional view taken along line IB-IB′ of FIG. 1A. The liquid crystal device 1 is an active matrix type liquid crystal device employing TFT elements 20 (FIG. 4) as switching elements and is also an OCB-mode liquid crystal device. The liquid crystal device 1 includes an element substrate 10 and a counter substrate 30 attached to each other with a frame-like sealing member 41 interposed therebetween to face each other. A liquid crystal layer 40 having a splay alignment state and a bend alignment state is enclosed in a space surrounded with the element substrate 10, the counter substrate 30, and the sealing member 41. A polarizing film 51 is disposed on the surface of the element substrate 10 opposite to the liquid crystal layer 40 and a polarizing film 53 is disposed on the surface of the counter substrate 30 opposite to the liquid crystal layer 40. The element substrate 10 is larger than the counter substrate 30 and a part thereof protrudes from the counter substrate 30. The protruding portion is mounted with a driver IC 42 for driving the liquid crystal layer 40.

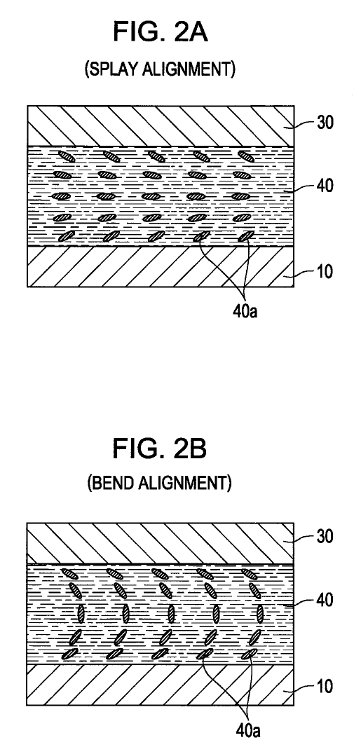

The liquid crystal device 1 performs a display operation in a display area 43 in which the liquid crystal layer 40 is enclosed. The liquid crystal layer 40 is initially in the splay alignment state shown in FIG. 2A and is transferred to a bend alignment state shown in FIG. 2B at the time of performing the display operation. The transfer from the splay alignment to the bend alignment is performed by applying a transfer voltage to the liquid crystal layer 40. In the bend alignment, liquid crystal molecules 40a included in the liquid crystal layer 40 are arranged in the form of a bow and transmittance is modulated to perform the display operation by changing a degree of bending of the bow shape.

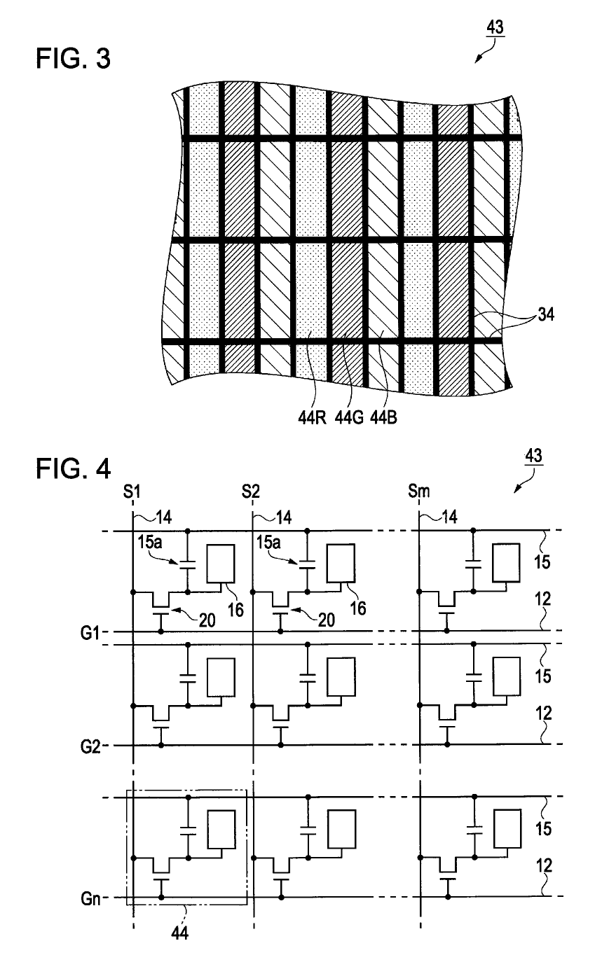

FIG. 3 is an enlarged plan view illustrating the display area 43. As shown in the drawing, the liquid crystal device 1 includes plural pixels 44R, 44G, and 44B (hereinafter, simply referred to as “pixels 44” when colors are not distinguished) corresponding to red, green, and blue. The pixels 44 are arranged in a matrix and the color of the pixels 44 in the same column is constant. In other words, the pixels 44 are arranged so that the corresponding colors extend in the form of stripes. A light-blocking layer 34 is formed in an area between the neighboring pixels 44. A group of pixels including three neighboring pixels 44R, 44G, and 44B arranged in a row direction constitutes a minimum display unit (pixel). The liquid crystal device 1 can display various colors by adjusting brightness balance of the pixels 44R, 44G, and 44B in the respective groups of pixels.

### B. Equivalent Circuit

FIG. 4 is an equivalent circuit diagram illustrating various elements and lines in the display area 43 of the liquid crystal device 1. In the display area 43, plural gate lines 12 and plural source lines 14 are formed to intersect each other. The pixels 44 are disposed to correspond to the intersections of the gate lines 12 and the source lines 14 and a pixel electrode 16 is formed in each pixel 44. Capacitor lines 15 are formed along the gate lines 12 and auxiliary capacitors 15a are formed between the pixel electrodes 16 and the capacitor lines 15.

TFT elements 20 as switching elements for controlling the voltage supply to the pixel electrodes 16 are formed at positions corresponding to the intersections of the gate lines 12 and the source lines 14. The source terminal of each TFT element 20 is electrically connected to the corresponding source line 14. The gate terminal of the TFT element 20 is electrically connected to the corresponding gate line 12. The drain terminal of the TFT element 20 is electrically connected to the corresponding pixel electrode 16.

### C. Pixel Structure

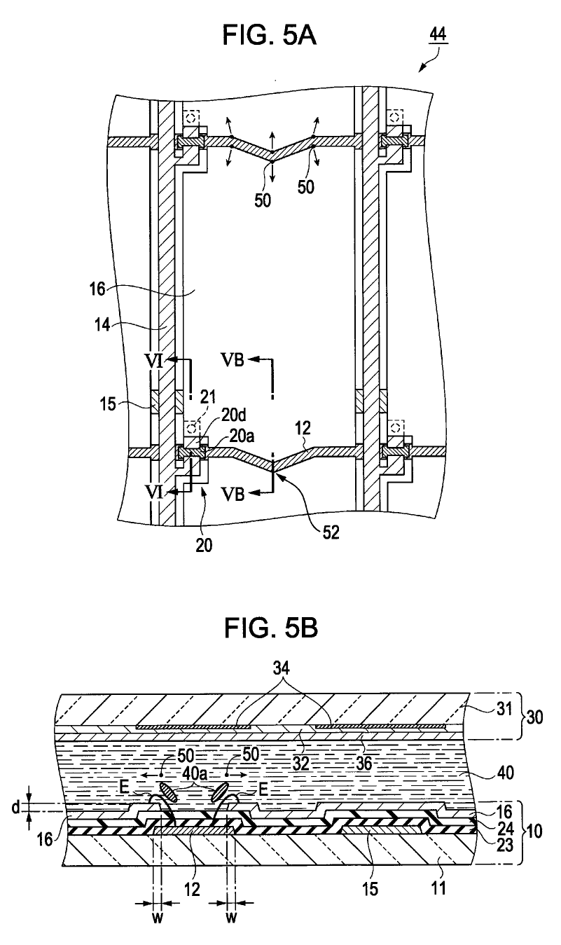

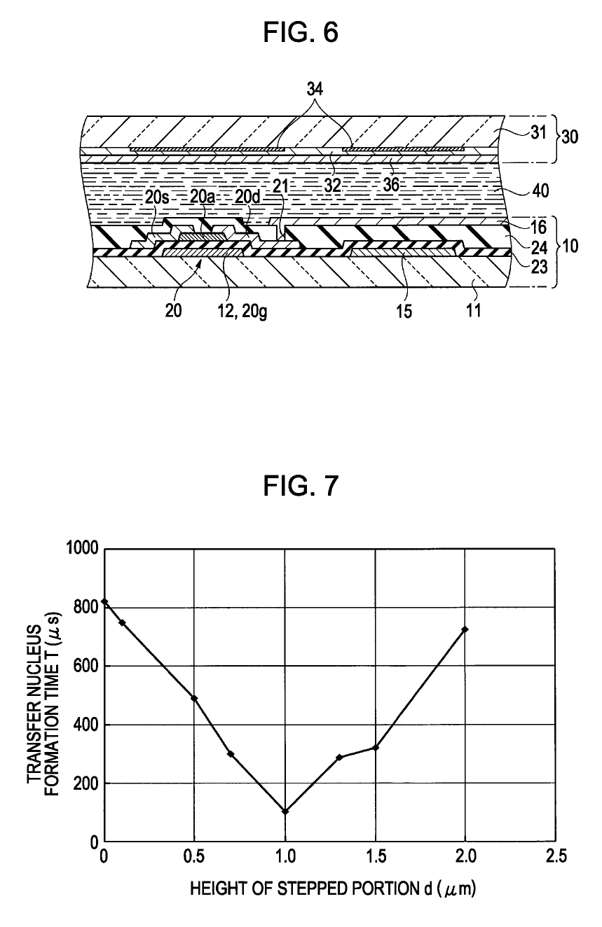

FIGS. 5A and 5B are diagrams illustrating a configuration of a pixel 44, where FIG. 5A is a plan view as viewed from the side of the counter substrate 30 and FIG. 5B is a sectional view taken along line VB-VB of FIG. 5A. FIG. 6 is a sectional view taken along line VI-VI of FIG. 5A. The configuration of each pixel 44 will be described now with reference to the drawings.

Elements formed on the element substrate 10 among elements of the pixel 44 are shown in FIG. 5A. The plural gate lines 12 arranged substantially parallel to each other, plural source lines 14 formed to intersect the gate lines 12 in a plan view, TFT elements 20 formed to correspond to the intersections of the gate lines 12 and the source lines 14, and pixel electrodes 16 electrically connected to the TFT elements 20 are formed on the element substrate 10. In this embodiment, the gate lines 12 and the source lines 14 are perpendicular to each other. The capacitor lines 15 are formed along the gate lines 12. One TFT element 20 and one pixel electrode 16 are formed in each pixel 44.

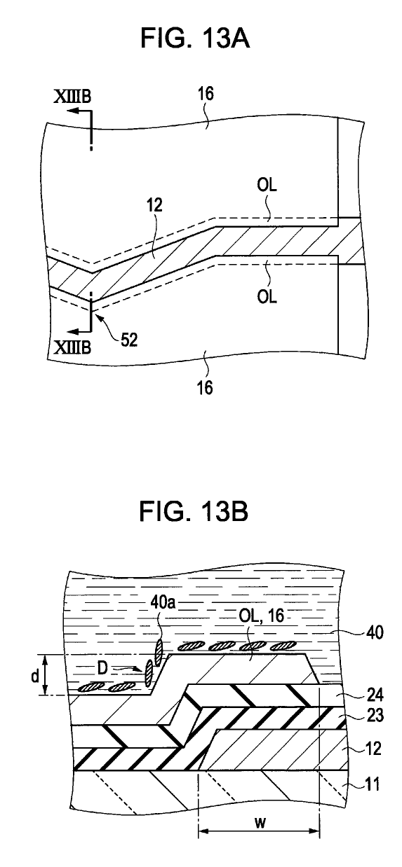

The pixel electrode 16 has two sides extending along two neighboring gate lines 12 and two sides extending along two neighboring source lines 14. The pixel electrode 16 is disposed in an area surrounded with the two neighboring gate lines 12 and the two neighboring source lines 14. The pixel electrode 16 partially overlaps with two gate lines 12 extending with the pixel electrode 16 interposed therebetween in a plan view. The area of the pixel electrode 16 overlapping with a part of the gate line 12 in a plan view is referred to as an overlap area. FIGS. 13A and 13B are diagrams illustrating the overlap area of the pixel electrode 16, where FIG. 13A is a plan view and FIG. 13B is a sectional view taken along line XIIIB-XIIIB of FIG. 13A. FIGS. 13A and 13B are also enlarged views of FIGS. 5A and 5B. In FIGS. 13A and 13B, reference sign OL represents the overlap area of the pixel electrode 16.

The gate lines 12 have a V-shaped curved portion 52. The side of the pixel electrode 16 extending along the gate line 12 is curved in a V shape along the curved portion 52 of the gate line 12. The overlap area of the pixel electrode 16 is disposed along the curved side. That is, an end portion of the pixel electrode 16 protrudes to the gate line 12 so as to overlap with a part of the curved portion 52 of the gate line 12 in a plan view.

A sectional structure of each pixel 44 will be described now. As shown in FIG. 6, the element substrate 10 includes a substrate 11 which is the first substrate as a base member. A glass substrate or a quartz substrate can be used as the substrate 11. A gate line 12 and a capacitor line 15 are formed on the surface of the substrate 11 facing the liquid crystal layer 40. An insulating layer formed of silicon oxide (SiO₂) or the like may be disposed between the substrate 11 and the gate line 12 and the capacitor line 15. A semiconductor layer 20a is formed on the gate line 12 with an interlayer insulating layer 23, which is formed of silicon oxide (SiO₂), interposed therebetween. The semiconductor layer 20a can be formed of, for example, amorphous silicon or polysilicon. A source electrode 20s and a drain electrode 20d are formed to partially overlap with the semiconductor layer 20a. The source electrode 20s can be formed monolithically with the source line 14 (see FIG. 5A). The semiconductor layer 20a, the source electrode 20s, the drain electrode 20d, and the gate line 12 constitute a TFT element 20. The gate line 12 also serves as a gate electrode 20g of the TFT element 20. The gate line 12 (the gate electrode 20g), the source electrode 20s, the drain electrode 20d, the source line 14, and the capacitor line 15 can be formed of, for example, metallic simple substance, alloy, metal silicide, polysilicide, or laminate thereof including at least one of high-melting-point metal such as titanium (Ti), chromium (Cr), tungsten (W), tantalum (Ta), and molybdenum (Me), or conductive polysilicon.

The pixel electrode 16 is formed on the TFT element 20 with the interlayer insulating layer 24, which is formed of silicon oxide (SiO₂), interposed therebetween. The pixel electrode 16 is electrically connected to the drain electrode 20d of the TFT element 20 through a contact hole 21 formed in the interlayer insulating layer 24. The pixel electrode 16 can be formed of, for example, indium tin oxide (ITO) having a light transmitting characteristic. The pixel electrode 16 is opposed to the capacitor line 15 and forms an auxiliary capacitor 15a (see FIG. 4) along with the capacitor line 15.

As shown in FIGS. 5B and 13B, the pixel electrode 16 includes the overlap area (represented by reference sign OL in FIGS. 13A and 13B) overlapping with the gate line 12 in a plan view. The overlapping width w (that is, the width of the overlap area in a direction perpendicular to the extension direction of the gate line 12) of the pixel electrode 16 and the gate line 12 is about 2 μm. The pixel electrode 16 has a stepped portion D (see FIG. 13B) between the overlap area and an area (an area not overlapping with the gate line 12) except the overlap area. The height (step difference) d of the stepped portion is preferably in the range of 0.1 μm to 2.0 μm. In this embodiment, the height d is 0.8 μm.

An alignment film (not shown) formed of polyimide is formed on the pixel electrode 16. The element substrate 10 includes the elements of from the substrate 11 to the alignment film.

The counter substrate 30 includes a substrate 31 which is a second substrate as a base member. A glass substrate or a quartz substrate can be used as the substrate 31. A light-blocking layer 34 formed of resin having a light-blocking characteristic is formed on the surface of the substrate 31 facing the liquid crystal layer 40. The light-blocking layer 34 is formed in the area between the neighboring pixel electrodes 16 in a plan view and at positions covering the area overlapping with the TFT element 20 or the capacitor line 15 in a plan view. The light-blocking layer 34 contributes to the improvement in display contrast by preventing light leakage between the pixels and blocking the reflected light from the TFT element 20 and the capacitor line 15. A color filter 32 is formed on the surface of the substrate 31 facing the liquid crystal layer 40. The color filter 32 includes three kinds of coloring elements corresponding to red, green, and blue and the coloring elements are disposed in the pixels 44R, 44G, and 44B, respectively. A light beam corresponding to the color of the color filter 32 is emitted from each pixel 44 to display a colorful image. The color filter 32 is also formed on the light-blocking layer 34.

A common electrode 36 formed of ITO is formed on the color filter 32. The common electrode 36 is formed substantially all over the display area 43 (see FIG. 1). An alignment film (not shown) formed of polyimide is formed on the common electrode 36. The counter substrate 30 includes the elements of from the substrate 31 to the alignment film.

As described above, the liquid crystal layer 40 is disposed between the element substrate 10 and the counter substrate 30. The alignment films of the element substrate 10 and the counter substrate 30 are all subjected to a rubbing process in a direction (lateral direction in FIG. 5A) along the gate line 12 in a plan view. Accordingly, liquid crystal molecules 40a included in the liquid crystal layer 40 are aligned in the direction along the gate line 12 when a voltage is not applied. Therefore, the liquid crystal layer 40 is aligned in a horizontal direction when a voltage is not applied. Known nematic liquid crystal can be used in the liquid crystal layer 40. For example, the thickness of the liquid crystal layer 40 can be set to 5 μm and An (birefringence index) of the liquid crystal molecules 40a can be set to 0.15.

Polarizing films 51 and 53 are disposed outside the element substrate 10 and the counter substrate 30, respectively (see FIG. 1). The transmission axes of the two polarizing films 51 and 53 are substantially perpendicular to each other and form an angle of 45° with respect to the rubbing direction (that is, the extension direction of the gate line 12) of the alignment films. A retardation film or an optical compensation film may be disposed between the polarizing films 51 and 53 and the element substrate 10 and the counter substrate 30 as needed. A negative uniaxial member (for example, WV film made by FUJIFILM CORPORATION) in which discotic liquid crystal molecules having negative refractive anisotropy and the like are aligned in hybrid or a positive uniaxial member (for example, NH film made by NIPPON OIL CORPORATION) in which nematic liquid crystal molecules having positive refractive anisotropy and the like are aligned in hybrid can be used as the optical compensation film. The negative uniaxial member and the positive uniaxial member may be combined. Otherwise, a biaxial member having refractive indexes in directions satisfying nx>ny>nz or a negative C-plate may be used.

A backlight (not shown) including a light source, a reflector, and a light guide plate is disposed outside the element substrate 10.

### D. Transfer Operation

By allowing the liquid crystal device 1 having the above-mentioned configuration to operate as follows, the liquid crystal layer 40 can be transferred from the splay alignment to the bend alignment.

First, in a first process, a transfer voltage is applied between the gate line 12 and the pixel electrode 16. The transfer voltage may be, for example, an AC rectangular wave of 5V and the application time thereof is, for example, 0.5 second. This process is performed by applying a transfer signal to the gate line 12 and applying a transfer signal to the source line 14 with the TFT elements 20 turned on to supply the signal to the pixel electrode 16.

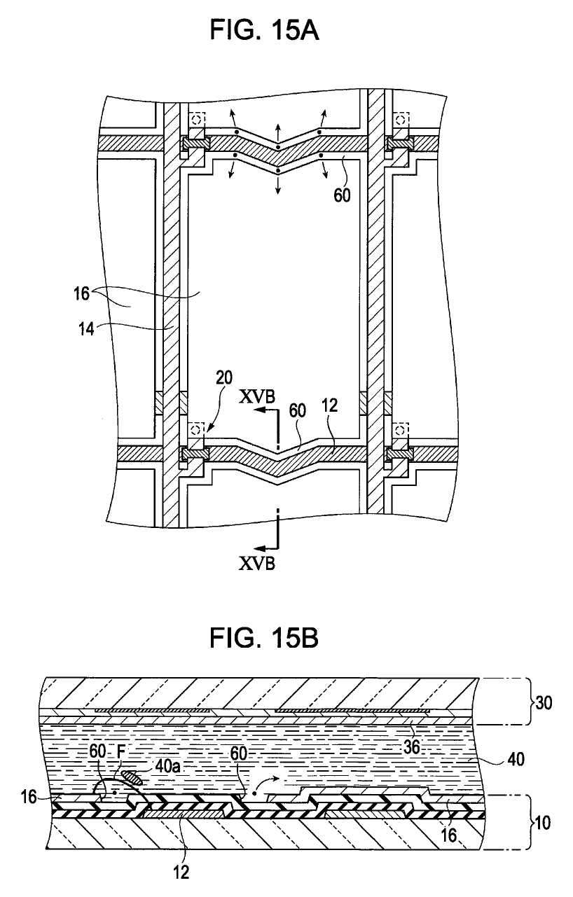

FIG. 5B shows an electric field E generated in the liquid crystal layer 40 and a behavior of the liquid crystal molecules 40a at this time. As shown in the drawing, since the gate line 12 and the pixel electrode 16 overlap with each other, the electric field E having many components in the normal direction (hereinafter, referred to as “vertical direction”) of the substrate 11 is generated between the gate line 12 and the pixel electrode 16 in the vicinity of the overlap area. For example, the electric field E has more components in the vertical direction than the electric field F (see FIGS. 15A and 15B) in the known liquid crystal device in which the gate line 12 and the pixel electrode 16 do not overlap with each other. The liquid crystal molecules 40a change their alignment direction along the direction of the electric field E. At this time, since the electric field E has many components in the vertical direction, the liquid crystal molecules 40a tend to change their alignment direction in the vertical direction. When the liquid crystal molecules 40a take such a behavior, the splay alignment is easily transferred to the bend alignment. Accordingly, transfer nucleuses for the bend alignment can be easily generated in the liquid crystal layer 40 due to the generation of the electric field E. Since the gate line 12 and the pixel electrode 16 partially overlap with each other, the distance between the gate line 12 and the pixel electrode 16 decreases in the vicinity of the overlap area, thereby generating the strong electric field E in the liquid crystal layer 40. Accordingly, in the first process, it is possible to generate the transfer nucleuses for the bend alignment with a low transfer voltage.

More specifically, when the transfer voltage is applied between the gate line 12 and the pixel electrode 16, the liquid crystal molecules 40a twist and get upright due to the transverse electric field in the overlap area on the pixel electrode 16 overlapping with the gate line 12. On the other hand, as shown in FIG. 13B, in the taper of the stepped portion D between the overlap area OL and the area other than the overlap area OL, the tilt angle of the liquid crystal molecules 40a about the plane of the substrate 11 increases. Accordingly, by applying the transfer voltage, it is possible to easily generate the transfer nucleuses for the bend alignment by the synergy effect of the twist in alignment of the liquid crystal molecules 40a in the overlap area OL and the tilt angle of the liquid crystal molecules 40a in the stepped portion D. Here, the generation positions of the transfer nucleuses (the transfer nucleus generation positions 50 in FIGS. 5A and 5B) are distributed in the vicinity of the boundary between the gate line 12 and the pixel electrode 16 in a plan view.

A relation between the height d of the stepped portion and the transfer nucleus formation time T is shown in Table 1 and FIG. 7. The transfer nucleus formation time T means a time taken from the application of the transfer voltage to the formation of the transfer nucleus.

TABLE 1

| d(μm) | T(μs) |
|---|---|
| 0.0 | 823 |
| 0.1 | 750 |
| 0.5 | 490 |
| 0.7 | 300 |
| 1.0 | 103 |
| 1.3 | 286 |
| 1.5 | 320 |
| 2.0 | 725 |

Since a satisfactory taper angle in the stepped portion is obtained by setting the height d of the stepped portion to 0.1 μm or more, it is possible to set the tilt angle of the liquid crystal molecules 40a in the taper of the stepped portion to a magnitude contributing to the generation of the transfer nucleus. As shown in Table 1 and FIG. 7, by setting the height d of the stepped portion to 0.1 μm, the transfer nucleus formation time T which was 823 μs when the stepped portion is not formed (d=0) is 750 μs, thereby reducing the transfer nucleus formation time T to about 10%.

By increasing the height d of the stepped portion, the taper angle of the stepped portion and the tilt angle of the liquid crystal molecules 40a in the vicinity thereof also increase and the degree of contribution thereof to the formation of the transfer nucleuses increases. However, since the distance between the gate line 12 and the pixel electrode 16 increases, the strength of the electric field is weakened. From this point of view, by setting the height d of the stepped portion to 2.0 μm or less, a satisfactory magnitude of electric field can be generated between the gate line 12 and the pixel electrode 16 and thus the degree of twist in alignment of the liquid crystal molecules 40a in the overlap area can be set to the magnitude contributing to the formation of the transfer nucleuses for the bend alignment. As shown in Table 1 and FIG. 7, when the height d of the stepped portion is set to 2.0 μm, the transfer nucleus formation time T is 725 μs and thus it is possible to reduce the transfer nucleus formation time T to about 10%, compared with the case where the stepped portion is not formed (d=0).

In this way, by setting the height of the stepped portion to the range of 0.1 μm to 2.0 μm, it is possible to obtain the synergy effect of the twist in alignment of the liquid crystal molecules 40a in the overlap area and the tilt angle of the liquid crystal molecules 40a in the stepped portion at the time of applying the transfer voltage to generate the transfer nucleuses. Particularly, when the height of the stepped portion is set to 1.0 μm, the above-mentioned two effects can be most accomplished and the transfer nucleus formation time T is reduced to 103 μs, which is 15% or less of that time in the case where the stepped portion is not formed. When the height of the stepped portion is set to the range of 0.7 μm to 1.3 μm, the transfer nucleus formation time T can be reduced to 40% or less of that time in the case where the stepped portion is not formed. In this embodiment, the height d of the stepped portion is 0.8 μm and the transfer nucleus formation time T is reduced to 30% or less (about 220 μs) of that time in the case where the stepped portion is not formed.

In a second process subsequent thereto, the transfer voltage is applied between the pixel electrode 16 and the common electrode 36. The transfer voltage can be, for example, an AC rectangular wave of 5 V. In this process, an electric field (vertical electric field) having a component in the normal direction of the substrate 11 is generated in the liquid crystal layer 40 on the pixel electrode 16. The liquid crystal molecules 40a are driven in the wide range on the pixel electrode 16 due to the electric field. As a result, the bend alignment area is spread onto the pixel electrode 16 from the transfer nucleuses generated in the first process. The bend alignment area is spread in the direction indicated by an arrow drawn from the transfer nucleus generation position 50 in FIGS. 5A and 5B.

Here, since the transfer nucleus generation position 50 is located in the vicinity of the boundary between the gate line 12 and the pixel electrode 16 in a plan view as described above, some of the transfer nucleuses are generated on the pixel electrode 16. Accordingly, when the bend alignment area is spread onto the pixel electrode 16 from the transfer nucleuses, the bend alignment area need not go over the great step difference. Therefore, it is possible to easily widen the bend alignment area and to widen the bend alignment area onto the pixel electrode 16 with a low transfer voltage.

In the area where the gate line 12 and the pixel electrode 16 overlap with each other, no gap is generated between the gate line 12 and the pixel electrode 16 in a plan view and thus no concave portion is formed between the gate line 12 and the pixel electrode 16. Accordingly, there dose not occur a situation that the transfer nucleuses are locked to the concave portion and are hardly spread out of the concave portion. Therefore, it is possible to easily widen the bend alignment area and to widen the bend alignment area onto the pixel electrode 16 with a low transfer voltage.

As described above, according to this embodiment, it is possible to generate the transfer nucleuses for the bend alignment with a low transfer voltage for a short time in the first process and to widen the bend alignment area with a low transfer voltage for a short time in the second process. Accordingly, in the liquid crystal device 1, it is possible to reduce the power consumption and the time for the transfer from the splay alignment to the bend alignment. A driving circuit with a low withstanding voltage specification can be used as the driving circuit used for a display operation.

### E. Display Operation

After transferring the liquid crystal layer 40 to the bend alignment, the following display operation can be performed.

As shown in FIG. 4, the gate lines 12 are supplied with scanning signals G1, G2, . . . , and Gn. The source lines 14 are supplied with image signals S1, S2, . . . , and Sm. When a gate line 12 has a selection potential, the TFT elements 20 connected to the gate line 12 are turned on. In the period when the TFT elements 20 are in the ON state, the image signals S1, S2, . . . , and Sm supplied to the source lines 14 are applied to the pixel electrodes 16 through the TFT elements 20. A voltage determined by the image signals S1, S2, . . . , and Sm with a predetermined level applied to the pixel electrodes 16 and a common potential of the common electrode 36 (see FIG. 5B) are applied as a driving voltage to the liquid crystal layer 40. The driving voltage is maintained by the capacitor of the liquid crystal layer 40 and the auxiliary capacitor 15a for a predetermined time. When the driving voltage is applied to the liquid crystal layer 40, the alignment state of the liquid crystal molecules 40a are changed depending on the applied voltage level. Accordingly, light incident on the liquid crystal layer 40 is modulated to enable the gray scale display.

Here, the effective value of the driving voltage is set greater than a threshold voltage of the liquid crystal layer 40 for maintaining the bend alignment. When the effective value of the driving voltage is smaller than the threshold voltage, a part of the liquid crystal layer 40 is inversely transferred to the splay alignment and the display of that portion is disturbed, thereby causing brightness unevenness. A “quasi-impulse display scheme” of inserting a black display may be employed to maintain the bend alignment.

### Second Embodiment

A second embodiment of the invention will be described now. The second embodiment is different from the first embodiment in the relative positional relation between the gate line 12 and the pixel electrode 16 in a plan view. The difference from the first embodiment will be mainly described now.

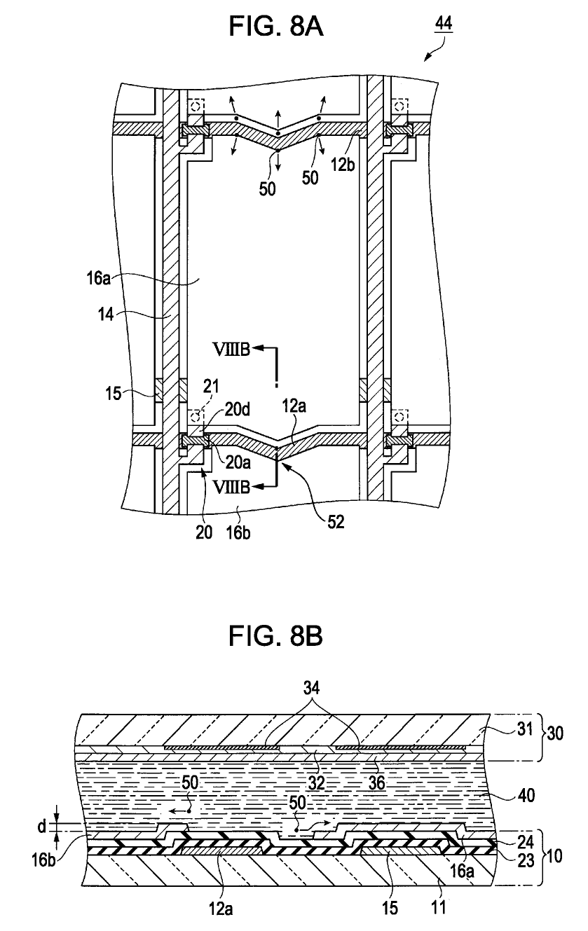

FIGS. 8A and 8B are diagrams illustrating a configuration of a pixel 44 in a liquid crystal device 1 according to this embodiment, where FIG. 8A is a plan view and FIG. 8B is a sectional view taken along line VIIIB-VIIIB of FIG. 8A. In FIGS. 8A and BB, a certain pixel electrode 16 is referred to as a pixel electrode 16a and a pixel electrode 16 adjacent to the pixel electrode 16a with the gate line 12 interposed therebetween is referred to as a pixel electrode 16b. The gate lines 12 connected to the pixel electrodes 16a and 16b with the TFT elements 20 interposed therebetween are referred to as gate lines 12a and 12b, respectively. The pixel electrode 16a overlaps in a plan view with a part of the gate line 12b not electrically connected to the pixel electrode 16a through the TFT element 20 among the two gate lines 12a and 12b disposed with the pixel electrode 16a interposed therebetween. That is, in this embodiment, the overlap area of the pixel electrode 16a overlaps with the gate line 12b but does not overlap with the gate line 12a. The gate line 12b overlapping with the pixel electrode 16a is not electrically connected to the pixel electrode 16a. Accordingly, even when parasitic capacitance is generated due to the overlapping in the overlap area, it is possible to suppress an influence on the display.

Paying attention to the pixel electrode 16b, a and b of the reference signs can be exchanged. That is, a part of the pixel electrode 16b overlaps with only the gate line 12a but does not overlap with the gate line 12b.

As shown in FIG. 8B, the gate line 12a overlaps with only the pixel electrode 16b in a plan view among the two pixel electrodes 16a and 16b with the gate line 12a interposed therebetween. In this way, by defining the area where the gate line 12 and the pixel electrode 16 overlap with each other, it is possible to reduce the parasitic capacitance generated due to the overlapping.

In the overlap area where the pixel electrode 16 (representing the pixel electrode 16a or the pixel electrode 16b, which is true in the following description) and the gate line 12 (representing the gate line 12a or the gate line 12b, which is true in the following description) overlap with each other, similarly to the first embodiment, it is possible to generate the transfer nucleuses for the bend alignment with a low transfer voltage for a short time and to widen the bend alignment area with a low transfer voltage for a short time.

Since the overlapping of the gate line 12 and the pixel electrode 16 in a plan view causes an increase in parasitic capacitance, it was not performed in the past. However, according to this embodiment, it is possible to accomplish an advantage resulting from the overlapping, that is, an advantage of easy transfer to the bend alignment, while suppressing the influence of the parasitic capacitance.

### Third Embodiment

A third embodiment of the invention will be described. The third embodiment is different from the second embodiment, in that an auxiliary electrode 13 is formed in each pixel 44. The difference from the second embodiment will be mainly described now.

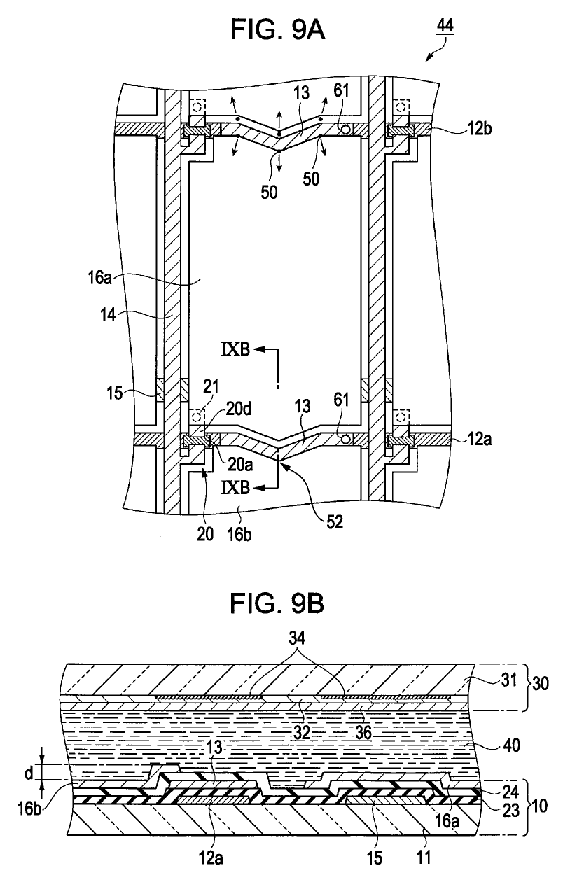

FIGS. 9A and 9B are diagrams illustrating a configuration of a pixel 44 in a liquid crystal device 1 according to this embodiment, where FIG. 9A is a plan view and FIG. 9B is a sectional view taken along line IXB-IXB of FIG. 9A. As shown in FIG. 9A, in a portion of the gate line 12 including the curved portion 52, an auxiliary electrode 13 is formed in an area overlapping with the gate line 12 in a plan view. Accordingly, the overlap area of the pixel electrode 16 overlapping with the gate line 12 also overlaps with the auxiliary electrode 13. In other words, the auxiliary electrode 13 is formed in the area overlapping with a part of the overlap area with the pixel electrode 16 in a plan view. The width of the auxiliary electrode 13 is greater than the width of the gate line 12 as shown in FIG. 9B. The auxiliary electrode 13 is formed in a layer between the interlayer insulating layer 23 and the interlayer insulating layer 24 out of the same material and by the same process as the source lines 14. Accordingly, it is possible to form the auxiliary electrode 13 without adding a new manufacturing process.

The auxiliary electrode 13 is electrically connected to the gate line 12 through a contact hole 61 formed in the interlayer insulating layer 23 and has a potential equivalent to that of the gate line 12. Accordingly, by applying the transfer voltage between the gate line 12 and the pixel electrode 16 in the transfer operation, the transfer voltage is applied between the auxiliary electrode 13 and the pixel electrode 16. Since only the interlayer insulating layer 24 exists between the auxiliary electrode 13 and the pixel electrode 16, the gap between the auxiliary electrode 13 and the pixel electrode 16 is smaller than the gap between the gate line 12 and the pixel electrode 16. Accordingly, it is possible to generate a strong electric field between the auxiliary electrode 13 and the pixel electrode 16 at the time of applying the transfer voltage and to further facilitate the transfer to the bend alignment.

Since the auxiliary electrode 13 is disposed in the area overlapping with both the pixel electrode 16 and the gate line 12 in a plan view, the height d of the stepped portion between the overlap area and the other area in the pixel electrode 16 can be made to increase by the thickness of the auxiliary electrode 13. In this embodiment, the height d of the stepped portion is 1.0 μm. As shown in FIG. 7, by setting the height d of the stepped portion to 1.0 μm, it is possible to reduce the transfer nucleus formation time T to 103 μs.

The auxiliary electrode 13 can be formed in the area overlapping with the overlap area in the pixel electrode 16 with the gate line 12 in a plan view and need not overlap with the entire gate line 12 in the width direction. The auxiliary electrode 13 may be formed of a material different from that of the source lines 14 as needed. The above-mentioned configuration having the auxiliary electrode 13 may be combined with the first embodiment.

### Fourth Embodiment

A fourth embodiment of the invention will be described now. The fourth embodiment is a modification of the third embodiment and the difference from the third embodiment will be mainly described now.

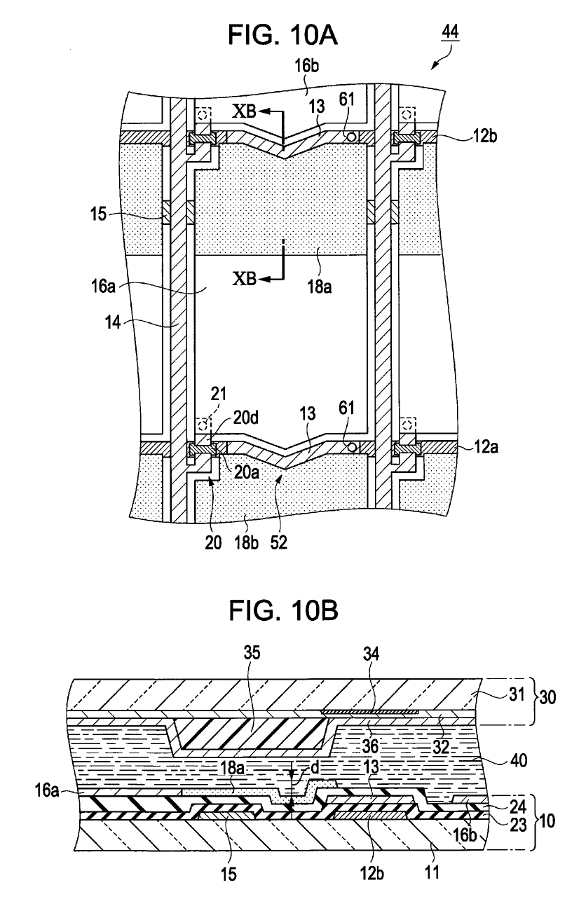

FIGS. 10A and 10B are diagrams illustrating a configuration of a pixel 44 in a liquid crystal device 1 according to this embodiment, where FIG. 10A is a plan view and FIG. 10B is a sectional view taken along line XB-XB of FIG. 10A. As shown in FIG. 10A, the gate line 12 has a V-shaped curved portion 52. Reflecting films 18a and 18b made of aluminum are formed in an area along the curved portion 52 in a plan view on the surface of the substrate 11 facing the liquid crystal layer 40. The reflecting films 18a and 18b are formed in the same layer as the pixel electrodes 16a and 16b and are electrically connected to the pixel electrodes 16a and 16b, respectively. Accordingly, the reflecting film 18 (representing the reflecting film 18a or the reflecting film 18b, which is true in the following description) serves as a part of the pixel electrode. In other words, in this embodiment, the pixel electrode includes a pixel electrode 16 as a transmissive electrode having a light transmitting property and a reflecting film 18 as a reflective electrode.

The area including the reflecting film 18 is a reflection display area contributing to a reflective display and the area not including the reflecting film 18 but including the pixel electrode 16 is a transmission display area contributing to a transmissive display. In the reflection display area, the display operation is performed by reflecting the light incident from the counter substrate 30 by the use of the reflecting film 18. In the transmission display area, the display operation is performed by transmitting the light incident from the element substrate 10 to the counter substrate 30. The capacitor line 15 is disposed in the reflection display area. Accordingly, it is possible to improve the aperture ratio of the transmission display area. In this embodiment, a λ/4 plate as a retardation film is disposed between the substrate 31 and the polarizing film 53 (see FIG. 1). A circularly polarizing film of a wide band may be formed by additionally disposing a λ/2 plate between the polarizing film 53 and the λ/4 plate. An optical compensation film for enlarging a viewing angle may be provided as needed.

The reflecting film 18a overlaps with only a part of the gate line 12b not electrically connected to the reflecting film 18a in a plan view. Similarly, the reflecting film 18b overlaps with only a part of the gate line 12a in a plan view. Accordingly, it is possible to reduce the parasitic capacitance resulting from the overlapping in the overlap area and to suppress the influence on the display even when the parasitic capacitance is generated. Similarly to the third embodiment, the auxiliary electrode 13 is disposed in the area overlapping with the portion including the curved portion 52 of the gate line 12 in a plan view. In this embodiment, the width of the auxiliary electrode 13 is greater than the width of the gate line 12 (see FIG. 9B).

As shown in FIG. 10B, a liquid-crystal-layer thickness adjusting layer 35 is formed in the area overlapping with the reflecting film 18 in a plan view on the surface of the substrate 31 facing the liquid crystal layer 40. Accordingly, the liquid-crystal-layer thickness adjusting layer 35 is disposed in the reflection display area. The liquid-crystal-layer thickness adjusting layer 35 can be formed of resin having a light transmitting property and can be formed, for example, in a layer between the color filter 32 and the common electrode 36. The thickness of the liquid-crystal-layer thickness adjusting layer 35 is adjusted so that the thickness of the liquid crystal layer 40 in the reflection display area is smaller than the thickness of the liquid crystal layer 40 in the transmission display area. When the thickness of the liquid crystal layer 40 in the reflection display area is set to ½ of the thickness of the liquid crystal layer 40 in the transmission display area, the thickness of the liquid crystal layer 40 in the reflection display area is about 2.5 μm. Accordingly, the distances by which the incident light passes through the liquid crystal layer 40 can be substantially equal to each other in the reflection display area and the transmission display area. Therefore, the optical conditions of the reflective display and the transmissive display can be set to obtain high-quality display.

In this configuration, when the transfer operation is performed, the transfer voltage is applied between the gate line 12 and the pixel electrode 16 in a first process. Accordingly, in the vicinity of the curved portion 52 of the gate line 12, the transfer nucleuses for the bend alignment are generated at a position corresponding to the boundary between the gate line 12 and the pixel electrode 16 in a plan view or in the vicinity thereof. Thereafter, in a second process, by applying the transfer voltage between the pixel electrode 16 and the common electrode 36, the transfer nucleuses are spread onto the pixel electrode 16. Here, since the vicinity of the curved portion 52 of the gate line 12 is the reflection display area, the transfer nucleuses are generated in the reflection display area in which the thickness of the liquid crystal layer 40 is small and the bend alignment area is spread to the reflection display area. In the reflection display area, since the gap between the pixel electrode 16 and the common electrode 36 is smaller than that of the transmission display area, the strength of the electric field generated in the liquid crystal layer 40 in the second process is increased. Accordingly, in the second process, the bend alignment area can be rapidly spread to the reflection display area. Alternatively, the bend alignment area can be spread with a low transfer voltage. Therefore, it is possible to reduce the power consumption for the transfer from the splay alignment to the bend alignment. To rapidly spread the bend alignment area onto the pixel electrode 16, it is preferable that the reflecting film 18 and the liquid-crystal-layer thickness adjusting layer 35 extend to the vicinity of the center of the pixel electrode 16.

The reflecting film 18 may be formed between the interlayer insulating layer 24 and the pixel electrode 16. In this case, the reflection display area has a structure in which the pixel electrode 16 is stacked on the reflecting film 18. According to this configuration, it is also possible to perform a reflective display operation using the reflecting film 18. The above-mentioned configuration having the reflecting film 18 and the liquid-crystal-layer thickness adjusting layer 35 may be put into practice by combination with the first embodiment or the second embodiment.

### Fifth Embodiment

A fifth embodiment of the invention will be described. The fifth embodiment is different from the second embodiment in shapes of the gate line 12, the source line 14, and the pixel electrode 16 in a plan view and relative positional relations therebetween.

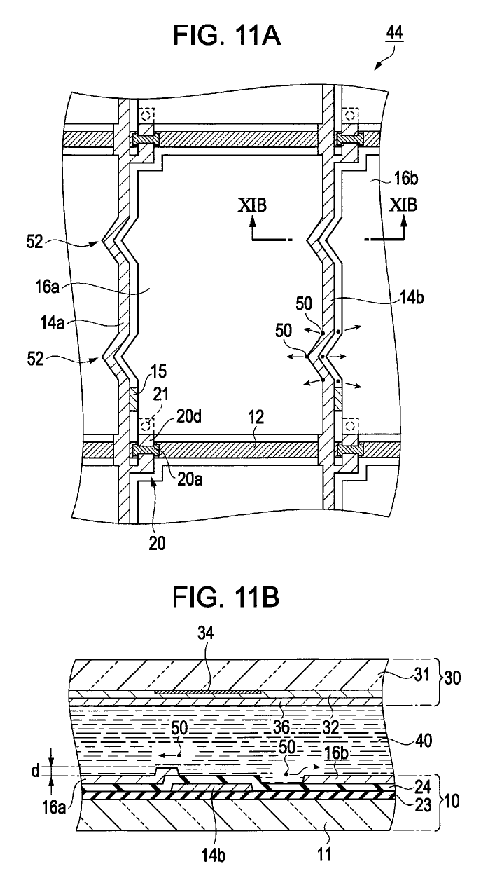

FIGS. 11A and 11B are diagrams illustrating a configuration of a pixel 44 in a liquid crystal device 1 according to this embodiment, where FIG. 11A is a plan view and FIG. 11B is a sectional view taken along line XIB-XIB of FIG. 11A. In FIGS. 11A and 11B, the source lines 14 connected to the pixel electrodes 16a and 16b through the TFT elements 20 are referred to as the source lines 14a and 14b, respectively.

As shown in FIG. 11A, in this embodiment, the curved portion is not formed in the gate line 12, but a V-shaped curved portion 52 is formed in the source lines 14a and 14b. The sides of the pixel electrode 16a along the source lines 14a and 14b are curved in a V shape along the curved portions 52 of the source lines 14a and 14b, but the sides along the gate line 12 are not curved. The source lines 14a and 14b have two curved portions 52 in one side of the pixel electrode 16a. In the transfer operation, the transfer voltage is applied between the source line 14a and the pixel electrode 16a in a first process.

The pixel electrode 16a overlaps in a plan view with only a part of the source line 14b not electrically connected to the pixel electrode 16a through the TFT element 20 among the two source lines 14a and 14b disposed with the pixel electrode 16a interposed therebetween. In this embodiment, the area of the pixel electrode 16a overlapping with the source line 14b corresponds to the overlap area. The overlap area of the pixel electrode 16a overlaps with the source line 14b, but does not overlap with the source line 14a. The source line 14b overlapping with the pixel electrode 16a is not electrically connected to the pixel electrode 16a. Accordingly, when a parasitic capacitance is generated due to the overlapping, it is possible to suppress the influence on the display.

Paying attention to the pixel electrode 16b, a and b of the reference signs can be exchanged. That is, a part of the pixel electrode 16b overlaps with only the source line 14a but does not overlap with the source line 14b.

As shown in FIG. 11B, the source line 14b overlaps with only the pixel electrode 16a in a plan view among the two pixel electrodes 16a and 16b with the source line 14a interposed therebetween. In this way, by defining the area where the source line 14 and the pixel electrode 16 overlap with each other, it is possible to reduce the parasitic capacitance generated due to the overlapping.

In the overlap area where the pixel electrode 16 and the source line 14 (which represents the source line 14a or the source line 14b, which is true in the following description) overlap with each other, similarly to the first embodiment, it is possible to generate the transfer nucleuses for the bend alignment with a low transfer voltage in the first process and to widen the bend alignment area with a low transfer voltage in the second process. Accordingly, it is possible to reduce the power consumption for the transfer from the splay alignment to the bend alignment. A driving circuit with a low withstanding voltage specification can be used as the driving circuit used for a display operation.

The above-mentioned configuration in which the source line 14 and the pixel electrode 16 overlap with each other can be put into practice by combination with the first to fourth embodiments.

### Sixth Embodiment

A sixth embodiment of the invention will be described. The sixth embodiment is different from the fifth embodiment, in that an auxiliary electrode 17 is formed in each pixel 44. The difference from the fifth embodiment will be mainly described now.

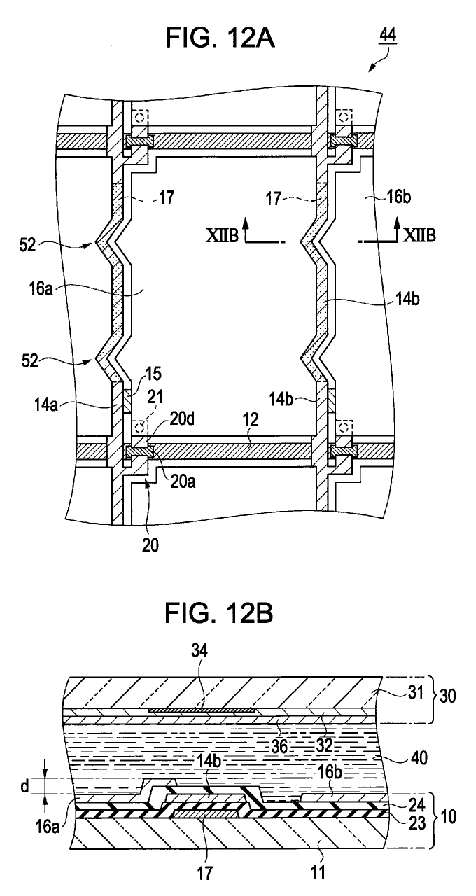

FIGS. 12A and 12B are diagrams illustrating a configuration of a pixel 44 in a liquid crystal device 1 according to this embodiment, where FIG. 12A is a plan view and FIG. 12B is a sectional view taken along line XIIB-XIIB of FIG. 12A. As shown in FIG. 12A, in a portion of the source line 14 including the curved portion 52, an auxiliary electrode 17 is formed in an area overlapping with the source line 14 in a plan view. Accordingly, the overlap area of the pixel electrode 16 overlapping with the source line 14 also overlaps with the auxiliary electrode 17. In other words, the auxiliary electrode 17 is formed in the area overlapping with a part of the overlap area with the pixel electrode 16 in a plan view. The width of the auxiliary electrode 17 is smaller than the width of the source line 14 as shown in FIG. 12B. The auxiliary electrode 17 is formed in a layer between the substrate 11 and the interlayer insulating layer 23 and is formed of the same material and by the same process as the gate lines 12. Accordingly, it is possible to form the auxiliary electrode 17 without adding a new manufacturing process.

Since the auxiliary electrode 17 is disposed in the area overlapping with both the pixel electrode 16 and the source line 14 in a plan view, the height d of the stepped portion between the overlap area and the other area in the pixel electrode 16 can be made to increase by the thickness of the auxiliary electrode 17. In this embodiment, the height d of the stepped portion is 1.0 μm. As shown in FIG. 7, by setting the height d of the stepped portion to 1.0 μm, it is possible to reduce the transfer nucleus formation time T to 103 μs.

The auxiliary electrode 17 can be formed in the area overlapping with the overlap area in the pixel electrode 16 with the source line 14 in a plan view and need not overlap with the entire source line 14 in the width direction. The auxiliary electrode 17 may be formed of a material different from that of the gate lines 12 as needed. The above-mentioned configuration having the auxiliary electrode 17 in which the source line 14 and the pixel electrode 16 overlap with each other may be combined with the first to fourth embodiments.

### Electronic Apparatus

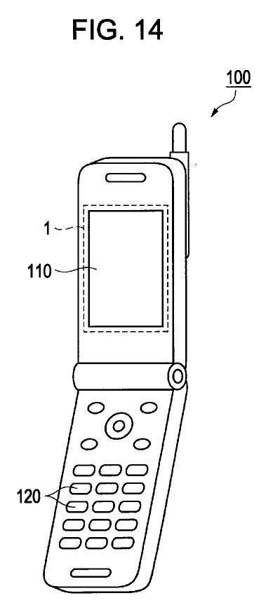

The above-mentioned liquid crystal device 1 can be mounted on an electronic apparatus such as a mobile phone. FIG. 14 is a perspective view illustrating a mobile phone 100 as an electronic apparatus. The mobile phone 100 includes a display unit 110 and operation buttons 120. The display unit 110 can display a variety of information such as details input from the operation buttons 120 or received information by the use of the liquid crystal device 1 mounted therein. Accordingly, in the electronic apparatuses having the above-mentioned configuration, it is possible to transfer the liquid crystal device 1 to the bend alignment mode with low power consumption for a short time. A driving circuit with a low withstanding voltage specification can be used as the driving circuit used for a display operation.

The liquid crystal device 1 can be used for various electronic apparatuses such as a mobile computer, a digital camera, a digital video camera, a vehicle-mounted apparatus, and an audio apparatus, in addition to the mobile phone 100. The liquid crystal device 1 can be mounted as a light valve on a projection display apparatus such as a projector.

Although various embodiments have been described hitherto, for example, the following modifications are made in the above-mentioned embodiments.

### MODIFIED EXAMPLE

The shape of the curve portion 52 formed in the gate line 12 or the source line 14 is not limited to the V shape, but may include, for example, a rectangular-waved portion. According to this configuration, it is also possible to easily generate the transfer nucleuses in the vicinity of the curved portion 52 when the transfer voltage is applied between the gate line 12 or the source line 14 and the pixel electrode 16.

The curved portion may not be formed in the gate line 12 and the source line 14. In this case, since the gate line 12 or the source line 14 partially overlaps with the pixel electrode 16, it is possible to perform the transfer to the bend alignment with a low transfer voltage.

The entire disclosure of Japanese Patent Application No. 2008-102191, filed Apr. 10, 2008 is expressly incorporated by reference herein.

What is claimed is:

1. A liquid crystal device comprising:
a first substrate;
a second substrate disposed to face the first substrate;
a liquid crystal layer disposed between the first substrate and the second substrate and capable of a splay alignment state and a bend alignment state;
a gate line formed between the first substrate and the liquid crystal layer;
a source line formed between the first substrate and the liquid crystal layer to intersect the gate lines in a plan view;
a switching element formed between the first substrate and the liquid crystal layer at a position corresponding to the intersection of the gate line and the source line; and
a pixel electrode formed between the first substrate and the liquid crystal layer and electrically connected to the switching element, the pixel electrode having an overlap area overlapping with at least a part of the gate line or the source line in a plan view and having a stepped portion between the overlap area and a central portion of the pixel electrode.

2. The liquid crystal device according to claim 1, wherein the height of the stepped portion is in the range of 0.1 μm to 2.0 μm.

3. The liquid crystal device according to claim 1, wherein the overlap area overlaps with a part of the gate line in a plan view, and
wherein an auxiliary electrode formed in the same layer as the source line is provided in an area overlapping with at least a part of the overlap area.

4. The liquid crystal device according to claim 1, wherein the overlap area overlaps with a part of the source line in a plan view, and
wherein an auxiliary electrode formed in the same layer as the gate line is provided in an area overlapping with at least a part of the overlap area.

5. The liquid crystal device according to claim 1, wherein the gate line or the source line has a curved portion,
wherein a side of the pixel electrode is curved along the curved portion, and
wherein the overlap area of the pixel electrode is disposed along the curved side.

6. The liquid crystal device according to claim 1, wherein each pixel electrode has two sides extending along two neighboring gate lines and two sides extending along two neighboring source lines, and
wherein the overlap area of the pixel electrode overlaps with a part of at least one of the gate line and the source line not electrically connected to the pixel electrode through the switching element among the two gate lines and the two source lines in a plan view.

7. The liquid crystal device according to claim 1, further comprising:
a reflecting film formed on an area along the curved portion in a plan view on the surface of the first substrate facing the liquid crystal layer; and
a liquid-crystal-layer thickness adjusting layer formed in an area overlapping with the reflecting film in a plan view on a surface of the second substrate facing the liquid crystal layer.

8. An electronic apparatus comprising the liquid crystal device according to claim 1.
